(19) United States
(12) Patent Application Publication
(10) Pub. No.: US 2010/0124698 A1
(43) Pub. Date: May 20, 2010

(54) BATTERY COVER ASSEMBLY FOR PORTABLE ELECTRONIC DEVICE

(75) Inventors: XI-QIU WU, Shenzhen City (CN); GUANG-XIANG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City, (CN); FIH (HONG KONG) LIMITED, Kowloon (HK)

(21) Appl. No.: 12/538,272

(22) Filed: Aug. 10, 2009

(30) Foreign Application Priority Data
Nov. 19, 2008 (CN) 200810305634.2

(51) Int. Cl. H01M 2/10

(52) U.S. Cl. 429/100

(57) ABSTRACT

A battery cover assembly comprises a housing, a battery cover, a magnetic element and iron core. The battery cover has a first surface facing the housing. The battery cover has a plurality of latching portions protruding from the first surface and located adjacent to one side thereof. The magnetic element is mounted to the first surface of the battery cover and located adjacent to anther side thereof. The iron core is mounted to the housing corresponding to the magnetic element. The magnetic element is magnetically attracted with the contacting portion and the latching portions are correspondingly latched in the latching slots, which corporately latches the battery cover to the housing.

### BACKGROUND

1. Technical Field

The exemplary disclosure generally relates to battery cover assemblies, and particularly to battery cover assemblies used in portable electronic devices.

2. Description of Related Art

Portable electronic devices usually include latch mechanisms for latching battery covers to housings. The latch mechanisms must tolerate frequent installation and removal of batteries relative to the housing.

A typical battery cover latch mechanism includes a battery cover and a housing. The battery cover may slide relative to and then latch with the housing by a sliding-type structure. However, the battery cover can be damaged during disassembly.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the exemplary battery cover assembly and portable electronic device using battery cover assembly. Moreover, in the drawings like reference numerals designate corresponding parts throughout the several views. Wherever possible, the same reference numbers are used throughout the drawings to refer to the same or like elements of an embodiment.

FIG. 1 is an exploded, schematic view of an exemplary embodiment of a battery assembly used for holding a battery therein, the battery assembly including a battery cover, a housing, magnetic element, an iron core and an inductance coil.

FIG. 2 is similar to FIG. 1, but showing the battery assembly in another view.

FIG. 3 is similar to FIG. 2, but the magnetic element is assembled to the batter cover, the iron core and the inductance coil are both assembled to the housing.

FIG. 4 is a schematic view of which a latching portion of the battery cover is latched into a latching slot of the housing.

FIG. 5 is an assembled view of the battery cover shown in FIG. 4.

FIG. 6 is a cross-sectional view of the battery cover shown in FIG. 5.

### DETAILED DESCRIPTION

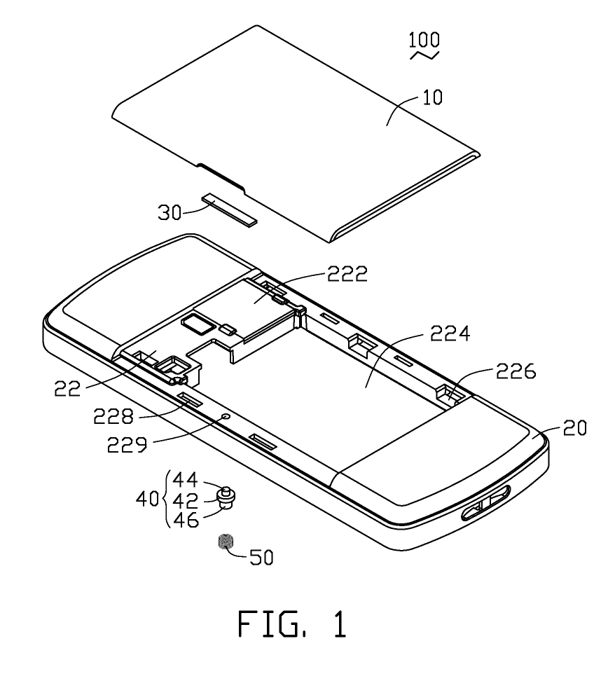

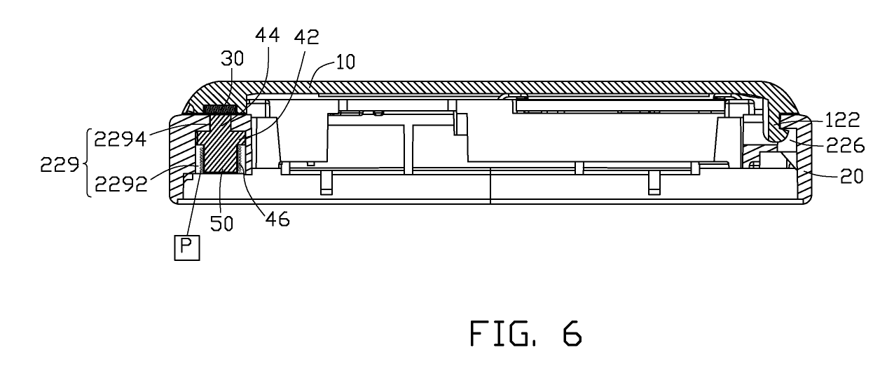

Referring to FIG. 1, an exemplary embodiment of a battery cover assembly 100 for accommodating a battery therein is shown. The battery cover assembly 100 includes a battery cover 10, a housing 20, a magnetic element 30 mounted to the battery cover 10, an iron core 40 mounted to the housing 20 and an inductance coil 50 wound to the iron core 40. Referring to FIG. 6, the battery cover 10 is latched with the housing 20 by the attractive force between the magnetic element 30 and the iron core 40. The inductance coil 50 is electrically connected to a power supply P disposed in the housing 20. When the power supply P electrifies the inductance coil 50, the inductance coil 50 forms an electric field having a magnetic pole opposite to that of the magnetic element 30, so a repulsive force is formed between the magnetic element 30 and the iron core 40. Thus, the latching engagement of the battery cover 10 and the housing 20 can be released when the repulsive force is larger than the attractive force.

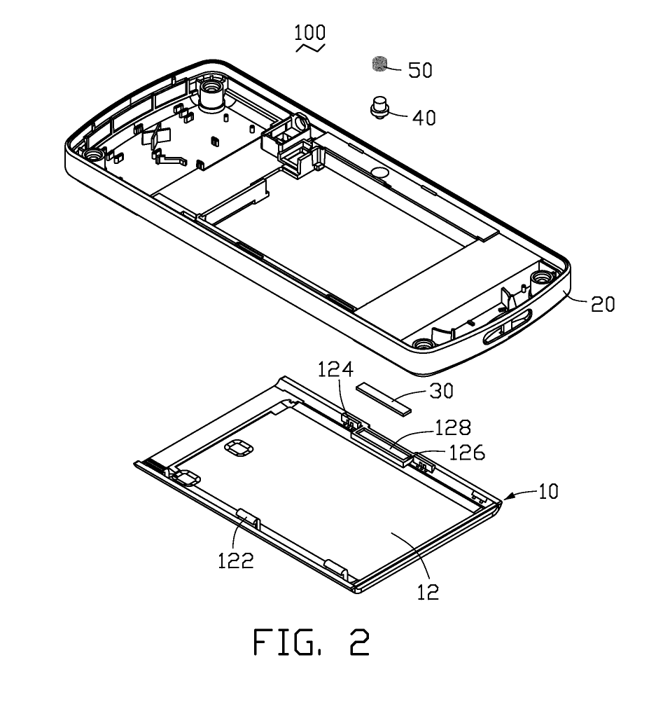

Referring to FIG. 2, the battery cover 10 includes a first surface 12 facing the housing 20. The battery cover 10 has two spaced latching portions 122 protruding from the first surface 12 and located adjacent to one side thereof. The battery cover 10 further has two spaced positioning portions 124 protruding from the first surface 12 and located adjacent to another side thereof. The battery cover 10 has a hollow frame 126 protruding from the first surface 12 between the positioning portions 124, and the frame 126 encloses a concave portion 128 for accommodating the magnetic element 30 therein.

The housing 20 has a receiving space 22 defined therein corresponding to the battery cover 10, and a bottom wall 222 defined in the receiving space 22. The receiving space 22 is configured for accommodating the battery cover 10 therein. The housing 20 has a compartment 224 defined in the bottom wall 222 for accommodating the battery therein.

The housing 20 has two spaced latching slots 226 corresponding to the latching portions 122 of the battery cover 10. Each of the latching slots 226 is configured to latch with a corresponding latching portion 122. The housing 20 has two spaced positioning holes 228 corresponding to the positioning portions 124 of the battery cover 10. The positioning holes 228 are configured to accommodate the positioning portions 124 therein, so the battery cover 10 and the housing 20 can be accurately assembled together.

The housing 20 has a mating space 229 (see FIG. 6) defined therethrough between the positioning holes 228. The mating space 229 is configured to accommodate the magnetic element 30 therein. The mating space 229 includes a first opening 2292 defined one side of the housing 20 and a second opening 2294 defined another side of the housing 20. The first opening 2292 is larger than the second opening 2294, and the first opening 2292 is communicated with the second opening 2294.

The iron core 40 includes a securing portion 42, a contacting portion 44 protruding outwardly from one end of the securing portion 42 and a retaining portion 46 protruding outwardly from another end of the securing portion 42. The securing portion 42 has the same shape as the first opening 2292 with a larger size than the first opening 2292. The contacting portion 44 has the same shape as the second opening 2294 and is accommodated in the second opening 2294. The contacting portion 44 is configured to contact with the magnetic element 30. The retaining portion 46 is configured to wind the inductance coil 50 thereon.

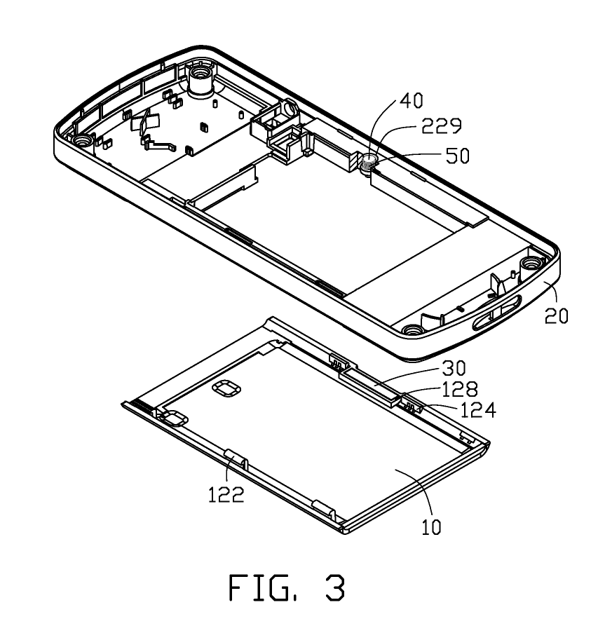

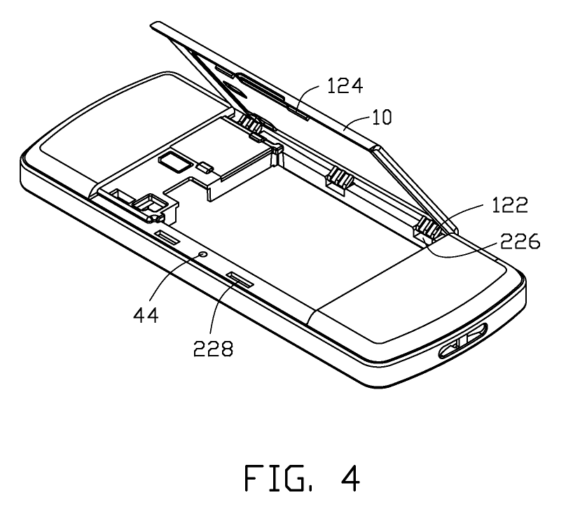

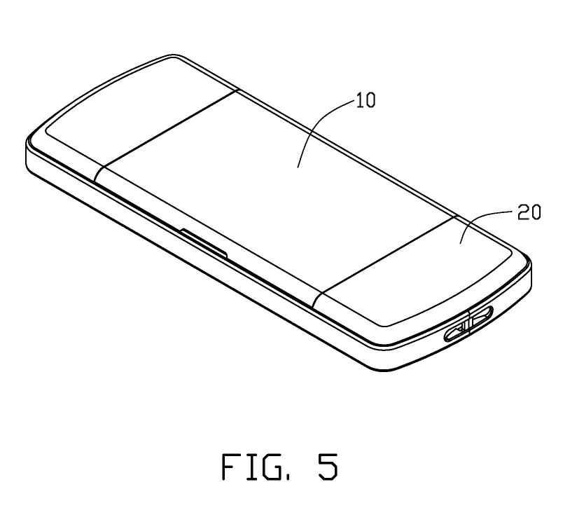

Referring to FIGS. 3 to 6, during assembling the battery cover 10 assembly, first, the magnetic element 30 is mounted (e.g., holt-melt) in the concave portion 128. The inductance coil 50 is wound on the retaining portion 46 of the iron core 40. The iron core 40 is accommodated in the mating space 229. At this time, the securing portion 42 is securely accommodated in the first opening 2292 to secure the iron core 40 in the mating space 229, the contacting portion 44 is accommodated in the second opening 2294. After that, the latching portions 122 of the battery cover 10 are received in the latching slots 226 of the housing 20. Then, the battery cover 10 is rotated about the latching portions 122 toward the housing 20, until the positioning portions 124 of the battery cover 10 are accommodated in the positioning holes 228 of the housing 20. At this stage, the magnetic element 30 is magnetically attracted with the contacting portion 44 to latching the battery cover 10 with the housing 20, i.e., yielding to an assembled battery cover assembly 1 00.

When detaching the battery cover 10 from the housing 20, the power supply P electrifies the inductance coil 50, the inductance coil 50 forms an electric field having a magnetic pole opposite to that of the magnetic element 30, so a repulsive force is formed between the magnetic element 30 and the iron core 40. Thus, the latching engagement of the battery cover 10 and the housing 20 can be released when the repulsive force is larger than the attractive force.

It is to be understood, the inductance coil 50 can be omitted, at this case, the latching engagement of the battery cover 10 and the housing 20 can be manually released.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover assembly comprising:
a battery cover, the battery cover having a first surface facing the housing, the battery cover having a plurality of latching portions protruding from the first surface and located adjacent to one side thereof;
a housing, the housing has a plurality of latching slots defined therein corresponding to the latching portions of the battery cover;
a magnetic element, the magnetic element mounted to the first surface of the battery cover and located adjacent to anther side thereof; and
an iron core, the iron core mounted to the housing at a position corresponding to the magnetic element;
wherein the magnetic element is magnetically attracted with the iron core and the latching portions are correspondingly latched in the latching slots, thereby latching the battery cover to the housing.

2. The battery cover assembly of claim 1, wherein the battery cover has a concave portion defined in the first surface for accommodating the magnetic element therein.

3. The battery cover assembly of claim 2, wherein the housing has a mating space defined therein corresponding to the concave portion of the battery cover, the iron core is securely accommodated in the mating space.

4. The battery cover assembly of claim 2, wherein the battery cover has a plurality of positioning portions protruding from the first surface and located at the same side of the battery cover as the concave portion is located, the housing has a plurality of positioning holes corresponding to the positioning portions, the positioning portions are accommodated in the positioning holes.

5. The battery cover assembly of claim 1, wherein the battery cover assembly further includes an inductance coil and a power supply mounted therein, the power supply electrifies the inductance coil to form a magnetic filed having a magnetic pole opposite to that of the magnetic element.

6. The battery cover assembly of claim 5, wherein the inductance coil is wound on the iron core.

7. The battery cover assembly of claim 6, wherein the iron core includes a securing portion, the mating space includes a first opening with a size smaller than the securing portion, the securing portion is securely accommodated in the first opening to secure the iron core on the housing.

8. The battery cover assembly of claim 7, wherein the iron core further includes a contacting portion protruding from one end of the securing portion, the mating space includes a second opening communicating with the first opening, the securing portion is accommodated in the second opening and contacts with the magnetic element.

9. The battery cover assembly of claim 8, wherein the iron core further includes a retaining portion protruding from another end of the securing portion, the inductance coil is wound on the retaining portion.

10. A battery cover assembly comprising:
a battery cover;
a housing;
a magnetic element, the magnetic element mounted to the battery cover; and
an iron core, the iron core mounted to the housing and aligned to the magnetic element;
wherein the magnetic element is magnetically attracted with the iron core to latch the battery cover to the housing.

11. The battery cover assembly of claim 10, wherein the battery cover has a concave portion defined therein for accommodating the magnetic element therein.

12. The battery cover assembly of claim 11, wherein the housing has a mating space defined therein corresponding to the concave portion of the battery cover, the iron core is securely accommodated in the mating space.

13. The battery cover assembly of claim 10, wherein the battery cover has a plurality of positioning portions protruding therefrom facing the housing, the housing has a plurality of positioning holes corresponding to the positioning portions, the positioning portions are accommodated in the positioning holes.

14. The battery cover assembly of claim 10, wherein the battery cover assembly further includes an inductance coil and a power supply mounted therein, the power supply electrifies the inductance coil to form a magnetic filed having a magnetic pole opposite to that of the magnetic element.

15. The battery cover assembly of claim 14, wherein the inductance coil is wound on the iron core.

16. The battery cover assembly of claim 15, wherein the iron core includes a securing portion, the mating space includes a first opening with a size smaller than the securing portion, the securing portion is securely accommodated in the first opening to secure the iron core on the housing.

17. The battery cover assembly of claim 16, wherein the iron core further includes a contacting portion protruding from one end of the securing portion, the mating space includes a second opening communicating with the first opening, the securing portion is accommodated in the second opening and contacts with the magnetic element.

18. The battery cover assembly of claim 17, wherein the iron core further includes a retaining portion protruding from another end of the securing portion, the inductance coil is wound on the retaining portion.
